(19) United States
(12) Patent Application Publication
(10) Pub. No.: US 2025/0308478 A1
(43) Pub. Date: Oct. 2, 2025

(54) DISPLAY MODULE AND ELECTRONIC DEVICE

(71) Applicant: SEIKO EPSON CORPORATION, Tokyo (JP)

(72) Inventors: Ryota BANSHO, MATSUMOTO-SHI (JP); Takeshi NOMURA, SHIOJIRI-SHI (JP)

(73) Assignee: SEIKO EPSON CORPORATION, Tokyo (JP)

(21) Appl. No.: 19/091,757

(22) Filed: Mar. 26, 2025

(30) Foreign Application Priority Data
Mar. 28, 2024 (JP) 2024-053710

(51) Int. Cl. G09G 3/36; G01K 7/01; G02F 1/133; G03B 21/00

(52) U.S. Cl. CPC G09G 3/3648; G02F 1/13306; G01K 7/01; G03B 21/006

(57) ABSTRACT

A display module includes an electro-optical device that includes a temperature detection element and is configured to display an image, a wiring board that includes a driving circuit configured to drive the electro-optical device, and a circuit board that includes a first control circuit configured to control the driving circuit and is electrically coupled to the electro-optical device via the wiring board. The driving circuit includes a measurement circuit configured to measure a temperature of the electro-optical device based on an output signal from the temperature detection element in a flyback period of the electro-optical device.

The present application is based on, and claims priority from JP Application Serial Number 2024-053710, filed Mar. 28, 2024, the disclosure of which is hereby incorporated by reference herein in its entirety.

### BACKGROUND

### 1. Technical Field

The present disclosure relates to a display module and an electronic device.

### 2. Related Art

A liquid crystal panel mounted on a projector as a light valve is irradiated with strong light emitted from a light source. Thus, the property of the liquid crystal panel is likely to change with a temperature rise. Therefore, there has been proposed a technique of detecting the temperature of the liquid crystal panel using a temperature detection element and adjusting the temperature of the liquid crystal panel based on the detected value of the temperature.

For example, according to a technique described in JP-A-2022-62887, a diode is provided as a temperature detection element on a substrate constituting a liquid crystal panel, and an A/D converter for converting a forward voltage Vf of the diode into a digital value is provided on a circuit board electrically coupled to the liquid crystal panel via a flexible wiring board.

According to the technique disclosed in JP-A-2022-62887, since the temperature detection element disposed on the liquid crystal panel and the A/D converter disposed on the circuit board are electrically coupled to each other via the flexible wiring board, the distance between the temperature detection element and the A/D converter is long. Therefore, the forward voltage Vf of the diode taken into the A/D converter is likely to fluctuate under the influence of disturbance noise.

According to the technique disclosed in JP-A-2022-62887, it is difficult to completely synchronize the timing of measuring the temperature, that is, the timing at which the A/D converter takes into the forward voltage Vf of the diode with the timing at which a driving integrated circuit (IC) supplies an image signal and a drive signal to the liquid crystal panel. Therefore, depending on the timing of measuring the temperature, the forward voltage Vf of the diode taken into the A/D converter may fluctuate under the influence of a power supply noise generated when each signal is supplied from the driving IC to the liquid crystal panel.

If the forward voltage Vf of the diode taken into the A/D converter fluctuates due to the two causes described above, accurate temperature data is difficult to acquire.

### SUMMARY

A display module according to an aspect of the present disclosure includes an electro-optical device that includes a temperature detection element and is configured to display an image, a wiring board that includes a driving circuit configured to drive the electro-optical device, and a circuit board that includes a first control circuit configured to control the driving circuit and is electrically coupled to the electro-optical device via the wiring board, wherein the driving circuit includes a measurement circuit configured to measure a temperature of the electro-optical device based on an output signal from the temperature detection element in a flyback period of the electro-optical device.

A display module according to an aspect of the present disclosure includes an electro-optical device that includes a temperature detection element and is configured to display an image, a wiring board, and a circuit board that is electrically coupled to the electro-optical device via the wiring board, wherein the electro-optical device includes a driving circuit configured to drive the electro-optical device, the circuit board includes a first control circuit configured to control the driving circuit, and the driving circuit includes a measurement circuit configured to measure a temperature of the electro-optical device based on an output signal from the temperature detection element in a flyback period of the electro-optical device.

An electronic device according to an aspect of the present disclosure includes the display module according to the above-described aspect of the present disclosure.

### BRIEF DESCRIPTION OF THE DRAWINGS

FIG. 1 is a plan view illustrating a schematic configuration of a liquid crystal panel used in a display module according to a first embodiment.

FIG. 2 is a diagram illustrating a schematic configuration of the display module according to the first embodiment.

FIG. 3 is a circuit diagram illustrating an example of a temperature detection circuit and a measurement circuit.

FIG. 4 is a diagram illustrating an operation state of the liquid crystal panel in one horizontal scanning period.

FIG. 5 is a diagram schematically illustrating a video signal in one frame period.

FIG. 6 is a diagram illustrating a schematic configuration of a display module according to a second embodiment.

FIG. 7 is a diagram illustrating a schematic configuration of a projector that is an example of an electronic device.

### DESCRIPTION OF EMBODIMENTS

Embodiments of the present disclosure will be described below with reference to the drawings. Also, in each figure below, in order to make each member a recognizable size, scales of each member may be different from actual ones. Further, in each drawing below, when necessary, XYZ axes are used as coordinate axes orthogonal to each other, and in each drawing, a direction indicated by each arrow along the axis is set as a + direction, and a direction opposite to the + direction is set as a − direction.

### 1. First Embodiment of Display Module

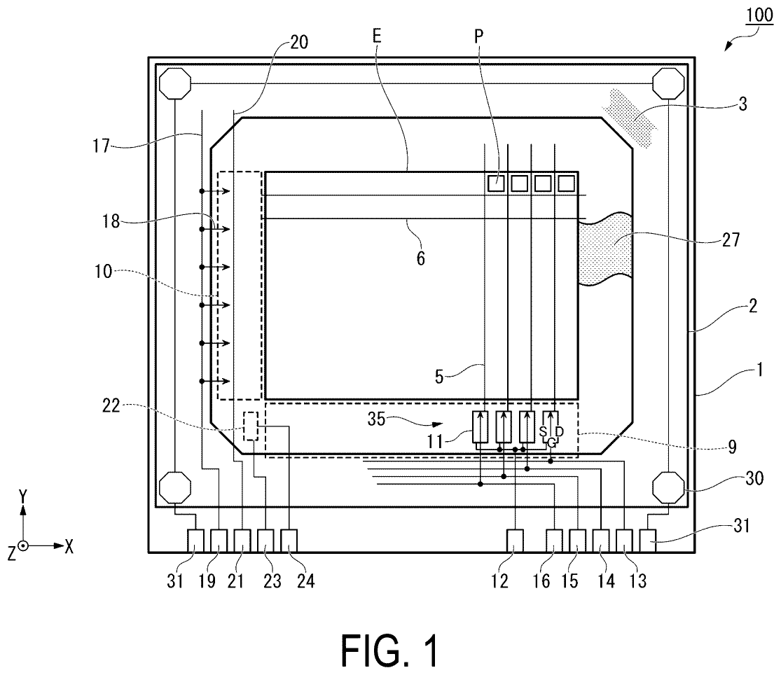

FIG. 1 is a plan view illustrating a schematic configuration of a liquid crystal panel 100 used in a display module 1000 according to a first embodiment. In FIG. 1, a +X direction may be referred to as rightward or a right side, and a −X direction may be referred to as leftward or a left side. Further, a +Y direction may be referred to as an upward or upper side, and a −Y direction may be referred to as a downward or lower side. Further, viewing from a +Z direction is called a plan view or planar manner.

For example, the liquid crystal panel 100 according to the present embodiment is an active drive type liquid crystal panel in which a plurality of pixels P having a pixel switching element such as a thin film transistor (TFT) are disposed in a display region E. The liquid crystal panel 100 constitutes the display module 1000 in combination with a wiring board 200 and a circuit board 300, which will be described below, and can be appropriately used as a light modulation device in a projector or the like, which is an example of an electronic device. The liquid crystal panel 100 is an example of an electro-optical device that includes a temperature detection element and displays an image.

The liquid crystal panel 100 includes an element substrate 1 and a counter substrate 2. The element substrate 1 and the counter substrate 2 are bonded to each other via a sealing material 3. The sealing material 3 is provided in a frame shape along an outer edge of the counter substrate 2. The sealing material 3 is an adhesive made of photocurable resin, thermosetting resin, or the like, and contains a gap material such as a glass fiber or a glass bead for setting a gap between the element substrate 1 and the counter substrate 2 to a predetermined size. In FIG. 1, only a part of the sealing material 3 is illustrated, and the remaining part of the sealing material 3 is omitted appropriately.

Although not illustrated in FIG. 1, a liquid crystal layer is disposed in a region sandwiched between the element substrate 1 and the counter substrate 2 and surrounded by the sealing material 3. For example, the liquid crystal layer is formed by using a liquid crystal dropping method of dropping liquid crystal. When the liquid crystal layer is formed by using the liquid crystal dropping method, a liquid crystal inlet for filling the liquid crystal is not present in the liquid crystal panel 100. The liquid crystal layer is configured of, for example, liquid crystal having negative dielectric anisotropy.

The element substrate 1 includes a display region E in the region surrounded by the sealing material 3. In the display region E, the plurality of pixels P are disposed in a matrix shape. In the display region E, a plurality of signal lines 5 extending in a Y-axis direction are disposed at a regular interval in an X-axis direction. In the display region E, a plurality of scanning lines 6 extending in the X-axis direction are disposed at a regular interval in the Y-axis direction. Each pixel P is disposed to correspond to one position at which the signal lines 5 and the scanning lines 6 intersect with each other.

Although not illustrated in FIG. 1, each pixel P includes a pixel electrode having a light transmitting property and the pixel switching element disposed to correspond to the pixel electrode. The pixel electrode is a transparent electrode formed of a transparent conductive material such as indium tin oxide (ITO), for example. The pixel switching element is, for example, an N-channel TFT.

For example, each signal line 5 is electrically coupled to a source of the pixel switching element of each pixel P corresponding to each signal line 5. Each scanning line 6 is electrically coupled to a gate of the pixel switching element of each pixel P corresponding to each scanning line 6. In each pixel P, a drain of the pixel switching element is electrically coupled to the pixel electrode.

The element substrate 1 includes a signal line driving circuit 9 and a scanning line driving circuit 10. In a region between the display region E and the sealing material 3, the signal line driving circuit 9 is disposed on the lower side of the display region E, and the scanning line driving circuit 10 is disposed on the left side of the display region E. A lower end of each signal line 5 is electrically coupled to the signal line driving circuit 9. A left end of each scanning line 6 is electrically coupled to the scanning line driving circuit 10.

For example, the signal line driving circuit 9 includes a plurality of demultiplexers 35. For example, each demultiplexer 35 includes four switching elements 11. FIG. 1 illustrates only the four switching elements 11 included in the demultiplexer 35 located on the rightmost side among the plurality of demultiplexers 35 included in the signal line driving circuit 9. For example, the switching element 11 is an N-channel TFT, similarly to the pixel switching element.

The drain (D) of each switching element 11 is electrically coupled to the signal line 5 corresponding to each switching element 11. The source (S) of each switching element 11 is electrically coupled to a video signal terminal 12. The video signal terminal 12 is one of a plurality of mounting terminals disposed at a lower end portion of the element substrate 1, and is used as an input terminal for a video signal VID.

The gate (G) of the rightmost switching element 11 among the four switching elements 11 is electrically coupled to a first selection signal terminal 13. The first selection signal terminal 13 is one of the plurality of mounting terminals and is used as an input terminal for a first selection signal SEL1.

The gate of the switching element 11 located second from the right among the four switching elements 11 is electrically coupled to a second selection signal terminal 14. The second selection signal terminal 14 is one of the plurality of mounting terminals and is used as an input terminal for a second selection signal SEL2.

The gate of the switching element 11 located third from the right among the four switching elements 11 is electrically coupled to a third selection signal terminal 15. The third selection signal terminal 15 is one of the plurality of mounting terminals and is used as an input terminal for a third selection signal SEL3.

The gate of the leftmost switching element 11 among the four switching elements 11 is electrically coupled to a fourth selection signal terminal 16. The fourth selection signal terminal 16 is one of the plurality of mounting terminals and is used as an input terminal for a fourth selection signal SEL4.

In the following description, the first selection signal SEL1 to the fourth selection signal SEL4 may be collectively referred to as a selection signal SEL.

The four switching elements 11 included in one demultiplexer 35 are controlled to be turned on or off according to the first selection signal SEL1 to the fourth selection signal SEL4. In one horizontal scanning period, each switching element 11 is exclusively controlled so that the switching element 11 is turned on, and the video signal VID is distributed and input to the video signal terminal 12 in synchronization with an on-timing of each switching element 11, so that the desired video signal VID is supplied to each signal line 5.

In order to ensure writing capability suitable for high-speed driving of the liquid crystal panel 100, a channel width of each switching element 11 is large. Therefore, typically, a disposition in which the gate electrode of each switching element 11 extends in the Y-axis direction is often used. The signal line driving circuit 9 is configured of the plurality of demultiplexers 35 including the four switching elements 11 as described above. In other words, the signal line driving circuit 9 includes a plurality of switching elements 11 electrically coupled to the plurality of signal lines 5 on a one-to-one basis.

For example, when the liquid crystal panel 100 is a full-high definition (FHD) panel, the signal line driving circuit 9 includes 1920/4=480 demultiplexers 35. For example, when each demultiplexer 35 includes eight switching elements 11, the signal line driving circuit 9 includes 1920/8=240 demultiplexers 35.

For example, the scanning line driving circuit 10 is configured of a sequential selection circuit such as a shift register. Therefore, typically, a clock signal main line 17 which is a main wire of a clock signal CLY extends in the Y-axis direction, and a plurality of clock signal branch lines 18 for supplying the clock signal CLY to a unit circuit of each shift register extend from the clock signal main line 17 to the right side. The clock signal main line 17 is electrically coupled to a clock signal terminal 19. The clock signal terminal 19 is one of the plurality of mounting terminals and is used as an input terminal for the clock signal CLY.

Although FIG. 1 illustrates a configuration in which the clock signal CLY input to the clock signal terminal 19 is directly supplied to the scanning line driving circuit 10 as an example, a configuration in which the clock signal CLY input to the clock signal terminal 19 is set to a low-amplitude signal, is converted into a high-amplitude signal by a level shift circuit disposed on the element substrate 1, and is supplied to the scanning line driving circuit 10 may be adopted.

Although FIG. 1 illustrates a configuration in which one clock signal CLY is supplied to the scanning line driving circuit 10 as an example, a configuration in which an inverted signal CLYB of the clock signal CLY is supplied to the scanning line driving circuit 10 together with the clock signal CLY may be adopted. In this case, the two clock signals CLY and CLYB are supplied to the shift register via a buffer circuit after a phase difference is adjusted by a phase difference correction circuit.

An output control signal ENBY for shaping a scanning line selection waveform is supplied to the scanning line driving circuit 10 via an output control signal line 20 extending in the Y-axis direction. The output control signal line 20 is electrically coupled to an output control signal terminal 21. The output control signal terminal 21 is one of the plurality of mounting terminals, and is used as an input terminal for the output control signal ENBY. For example, the output control signal ENBY is input to an AND circuit together with an output signal from each stage of the shift register, and an output signal from the AND circuit is supplied to the scanning line 6 via a buffer circuit appropriately as a scanning signal for turning on the pixel switching element.

As is understood from the above description, the scanning line driving circuit 10 sequentially selects the plurality of scanning lines 6 disposed in the display region E in synchronization with the clock signal CLY. More specifically, the scanning line driving circuit 10 sequentially supplies a scanning signal to each scanning line 6 in synchronization with the clock signal CLY. A period in which one scanning line 6 is selected, that is, a period in which a scanning signal is supplied to one scanning line 6 is included in one horizontal scanning period.

In FIG. 1, the configuration in which one scanning line driving circuit 10 is disposed on the left side of the display region E is illustrated, but in practice, a configuration in which the scanning line driving circuits 10 are disposed on both the left side and the right side of the display region E is often used in order to cope with high-speed driving. Although not illustrated in FIG. 1, the element substrate 1 includes a first alignment film disposed to cover the display region E.

The counter substrate 2 includes a light shielding film 27 having a light shielding property, a common electrode having a light transmitting property, and a second alignment film disposed to cover the common electrode. In FIG. 1, an illustration of the common electrode and the second alignment film is omitted. The light shielding film 27 is disposed to surround the display region E in plan view. In FIG. 1, only a part of the light shielding film 27 is illustrated, and the remaining part of the light shielding film 27 is appropriately omitted. The common electrode is formed of a transparent conductive material such as ITO, for example. The common electrode is electrically coupled to two common potential terminals 31 of the element substrate 1 via transfers 30 disposed to correspond to four corners of the counter substrate 2.

The common potential terminal 31 is one of the plurality of mounting terminals and is used as an input terminal for a common potential Vcom. The common potential Vcom input to the common potential terminal 31 is supplied to the common electrode via the four transfers 30. Although not illustrated, the common potential Vcom input to the common potential terminal 31 is also supplied to one end of an auxiliary capacitor included in the pixel circuit disposed on the element substrate 1. The common potential Vcom may be supplied to each of the common electrode and the auxiliary capacitor through separate systems.

The element substrate 1 includes a temperature detection circuit 22 that detects the temperature of the liquid crystal panel 100. The temperature detection circuit 22 is electrically coupled to each of a first temperature detection terminal 23 and a second temperature detection terminal 24. Each of the first temperature detection terminal 23 and the second temperature detection terminal 24 is one of the plurality of mounting terminals, and is used for electrically coupling the temperature detection circuit 22 to a measurement circuit 220 described below. As will be described in detail below, the temperature detection circuit 22 includes a diode 51 as a temperature detection element. That is, the liquid crystal panel 100 includes the diode 51 as a temperature detection element.

For example, the temperature detection circuit 22 is disposed at a position overlapping the light shielding film 27 in plan view. FIG. 1 illustrates an example in which the temperature detection circuit 22 is disposed at the lower left of the display region E in a region overlapping the light shielding film 27 in plan view, but how the temperature detection circuit 22 is disposed is not limited thereto. Still, the temperature detection circuit 22 is desirably disposed at a position close to the first temperature detection terminal 23 and the second temperature detection terminal 24 so that a distance between the temperature detection circuit 22 and the measurement circuit 220 is made as short as possible.

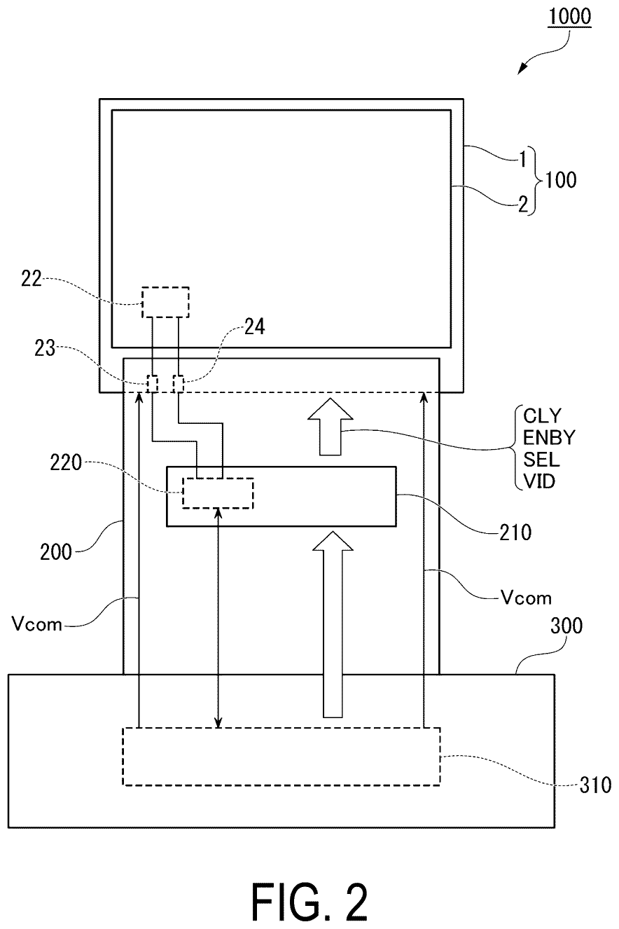

FIG. 2 is a diagram illustrating a schematic configuration of the display module 1000 according to the first embodiment. The display module 1000 includes the liquid crystal panel 100, the wiring board 200, and the circuit board 300. The wiring board 200 includes a driving integrated circuit (IC) 210 that drives the liquid crystal panel 100. For example, the wiring board 200 is a flexible printed circuit board such as a flexible printed circuit (FPC). The circuit board 300 includes a first control circuit 310 that controls the driving IC 210.

The liquid crystal panel 100 is electrically coupled to the circuit board 300 via the wiring board 200. More specifically, of the plurality of mounting terminals disposed on the element substrate 1 of the liquid crystal panel 100, the two common potential terminals 31 are electrically coupled to the first control circuit 310 of the circuit board 300 via the wiring board 200. The other mounting terminals including the video signal terminal 12, the first selection signal terminal 13, the second selection signal terminal 14, the third selection signal terminal 15, the fourth selection signal terminal 16, the clock signal terminal 19, the output control signal terminal 21, the first temperature detection terminal 23, and the second temperature detection terminal 24 are electrically coupled to the driving IC 210 of the wiring board 200. The driving IC 210 is electrically coupled to the first control circuit 310 of the circuit board 300.

In FIG. 2, of the plurality of mounting terminals of the liquid crystal panel 100, the mounting terminals other than the first temperature detection terminal 23 and the second temperature detection terminal 24 are not illustrated.

The clock signal CLY, the output control signal ENBY, the selection signal SEL, the video signal VID, and the like are supplied from the driving IC 210 to the liquid crystal panel 100. The common potential Vcom is directly supplied from the first control circuit 310 to the liquid crystal panel 100. The first control circuit 310 controls the driving IC 210 so that various signals necessary for driving of the liquid crystal panel 100 are output from the driving IC 210 at the time of the normal driving of the liquid crystal panel 100. The driving IC 210 outputs the clock signal CLY, the output control signal ENBY, the video signal VID, the selection signal SEL, and the like to the liquid crystal panel 100 under the control of the first control circuit 310. The selection signal SEL includes the first selection signal SEL1 to the fourth selection signal SEL4. Signals output from the driving IC 210 include a start pulse signal to the scanning line driving circuit 10, a scanning direction designation signal, or the like in addition to the above signals.

As described above with reference to FIG. 1, in the liquid crystal panel 100, the common potential Vcom input to the common potential terminal 31 is supplied to the common electrode via the transfers 30. The clock signal CLY input to the clock signal terminal 19 is supplied to the scanning line driving circuit 10 via the clock signal main line 17 and the clock signal branch line 18. The output control signal ENBY input to the output control signal terminal 21 is supplied to the scanning line driving circuit 10 via the output control signal line 20.

The video signal VID input to the video signal terminal 12 is supplied to the source of each switching element 11 of all the demultiplexers 35 included in the signal line driving circuit 9. For example, the first selection signal SEL1 to the fourth selection signal SEL4 among the selection signals SEL input to the first selection signal terminal 13 to the fourth selection signal terminal 16 are supplied to the gate electrodes of the four switching elements 11 included in the demultiplexer 35 located on the rightmost side of the signal line driving circuit 9.

The video signal VID and the selection signal SEL are supplied to the signal line driving circuit 9 and the clock signal CLY and the output control signal ENBY are supplied to the scanning line driving circuit 10, so that a scanning signal for switching the pixel switching element of each pixel P to the on state is sequentially supplied to each scanning line 6 and the potential applied to the pixel electrode of each pixel P is supplied to each signal line 5. As a result, a light transmittance of each pixel P becomes a value determined by a potential difference between the pixel electrode and the common electrode. Thus, a state in which the liquid crystal panel 100 operates as a light modulation device by the light transmittance of each pixel P being controlled, to display a video, is referred to as the time of the normal driving of the liquid crystal panel 100. In addition, in each pixel P, AC driving is performed at the time of the normal driving in which a video is displayed, and a polarity of a voltage applied to the liquid crystal layer of each pixel P is inverted for each one frame period in which update of a transmittance state of the pixel P included in the display region E is completed.

The driving IC 210 includes the measurement circuit 220. The measurement circuit 220 is electrically coupled to the temperature detection circuit 22 of the liquid crystal panel 100 via the first temperature detection terminal 23 and the second temperature detection terminal 24 among the plurality of mounting terminals disposed on the element substrate 1 of the liquid crystal panel 100. The measurement circuit 220 is also electrically coupled to the first control circuit 310 of the circuit board 300. As will be described below in detail, the measurement circuit 220 measures the temperature of the liquid crystal panel 100 based on an output signal from the temperature detection element in a flyback period of the liquid crystal panel 100. In the present embodiment, the temperature detection element is the diode 51 included in the temperature detection circuit 22, and the output signal from the temperature detection element is the forward voltage Vf of the diode 51.

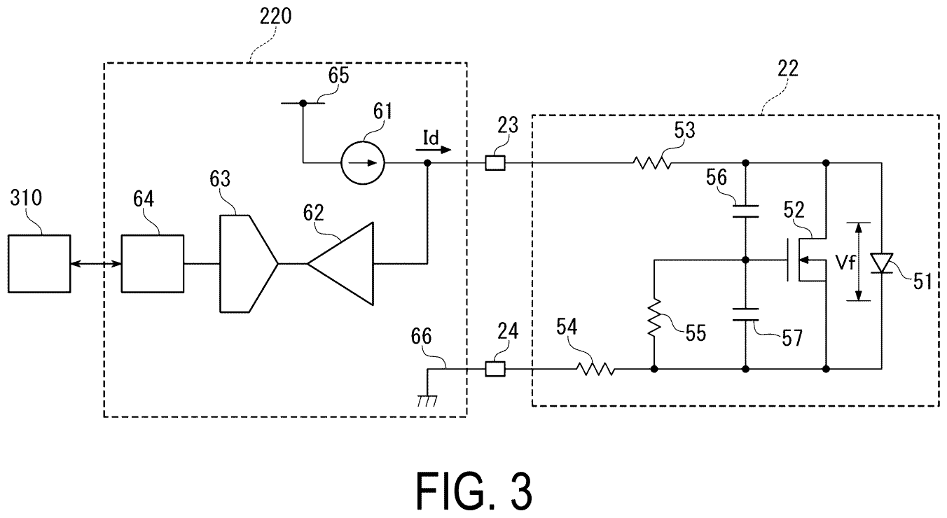

FIG. 3 is a circuit diagram illustrating an example of the temperature detection circuit 22 and the measurement circuit 220. The temperature detection circuit 22 includes the diode 51 as a temperature detection element, an N-channel transistor 52, a first resistance element 53, a second resistance element 54, a third resistance element 55, a first capacitor 56, and a second capacitor 57.

The diode 51 has an anode terminal electrically coupled to the first temperature detection terminal 23 via the first resistance element 53. The diode 51 has a cathode terminal electrically coupled to the second temperature detection terminal 24 via the second resistance element 54. Although FIG. 3 illustrates an example in which one diode 51 is used as the temperature detection element, a plurality of the diodes 51 coupled in series may be used in order to increase temperature detection sensitivity.

The N-channel transistor 52 has a drain terminal electrically coupled to the anode terminal of the diode 51. The N-channel transistor 52 has a source terminal electrically coupled to the cathode terminal of the diode 51. The N-channel transistor 52 has a gate terminal electrically coupled to the cathode terminal of the diode 51 via the third resistance element 55.

One end of the first capacitor 56 is electrically coupled to the drain terminal of the N-channel transistor 52. The other end of the first capacitor 56 is electrically coupled to the gate terminal of the N-channel transistor 52. One end of the second capacitor 57 is electrically coupled to the gate terminal of the N-channel transistor 52. The other end of the second capacitor 57 is electrically coupled to the source terminal of the N-channel transistor 52.

The measurement circuit 220 includes a constant current source 61, a buffer 62, an A/D converter 63, a second control circuit 64, a power supply wire 65, and a ground wire 66. The power supply wire 65 is a wire to which a power supply potential of the measurement circuit 220 is applied. The ground wire 66 is a wire to which a ground potential is applied. The power supply wire 65 is electrically coupled to the first temperature detection terminal 23 via the constant current source 61. The ground wire 66 is electrically coupled to the second temperature detection terminal 24.

The constant current source 61 is electrically coupled between the power supply wire 65 and the first temperature detection terminal 23, and supplies a driving current Id to the diode 51 via the first temperature detection terminal 23. The buffer 62 has an input terminal electrically coupled to the first temperature detection terminal 23. The buffer 62 has an output terminal electrically coupled to the A/D converter 63. The buffer 62 outputs a potential difference between the first temperature detection terminal 23 and the second temperature detection terminal 24 to the A/D converter 63 as the forward voltage Vf of the diode 51. For example, the buffer 62 is a voltage follower.

The A/D converter 63 is electrically coupled to the second control circuit 64, and converts the forward voltage Vf of the diode 51 input from the buffer 62 into a digital value at a timing instructed by the second control circuit 64. The A/D converter 63 outputs the digital value of the forward voltage Vf of the diode 51 to the second control circuit 64 as temperature data. The second control circuit 64 controls the A/D converter 63, and outputs the temperature data obtained from the A/D converter 63 to the first control circuit 310 of the circuit board 300.

The forward voltage Vf of the diode 51, which is generated when the driving current Id is supplied from the measurement circuit 220 to the temperature detection circuit 22, linearly decreases as the temperature increases. In other words, the forward voltage Vf of the diode 51 has temperature dependence. Therefore, the temperature of the liquid crystal panel 100 can be measured by detecting the potential difference between the first temperature detection terminal 23 and the second temperature detection terminal 24 as the forward voltage Vf of the diode 51.

In addition, for example, when a surge current due to static electricity enters the temperature detection circuit 22 from the first temperature detection terminal 23, the gate potential of the N-channel transistor 52 increases while the voltage fluctuation is suppressed by the first resistance element 53. As a result, the N-channel transistor 52 is turned on, and thus the surge current flows to the second temperature detection terminal 24 via the N-channel transistor 52. The period during which the N-channel transistor 52 is in the on state is determined by the gate capacities of the first capacitor 56, the second capacitor 57, the third resistance element 55, the N-channel transistor 52, and the like. After the discharge, the third resistance element 55 causes the gate potential of the N-channel transistor 52 to return to the off potential. As described above, since the surge current flowing through the diode 51 due to static electricity or the like is suppressed by the circuit configuration of the temperature detection circuit 22, the diode 51 can be protected from the surge current.

In the first embodiment, the driving IC 210 disposed on the wiring board 200 that electrically couples the liquid crystal panel 100 to the circuit board 300 includes the measurement circuit 220. Therefore, the distance between the diode 51, which is the temperature detection element disposed on the liquid crystal panel 100, and the A/D converter 63 included in the measurement circuit 220 is shorter than that with the known technique in which the measurement circuit 220 is disposed on the circuit board 300. Therefore, according to the first embodiment, the forward voltage Vf of the diode 51 taken into the A/D converter 63 is less likely to be affected by disturbance noise than with the known technique, whereby it is possible to improve the temperature measurement accuracy of the liquid crystal panel 100.

Further, in the first embodiment, in order to prevent the forward voltage Vf of the diode 51 taken into the A/D converter 63 from being affected by power supply noise, the second control circuit 64 controls the A/D converter 63 to make the forward voltage Vf of the diode 51 taken into the A/D converter 63 in the flyback period of the liquid crystal panel 100.

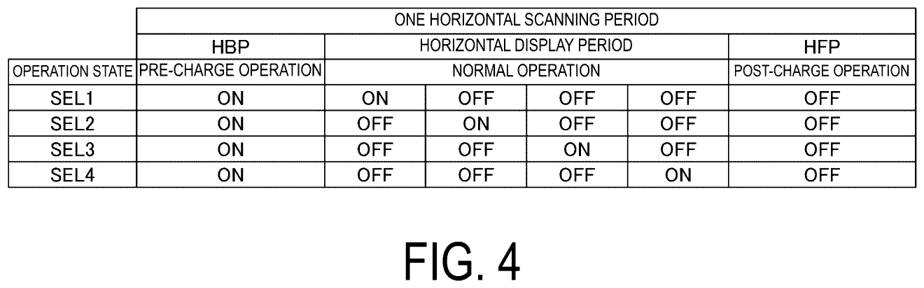

FIG. 4 is a diagram illustrating an operation state of the liquid crystal panel 100 in one horizontal scanning period. As illustrated in FIG. 4, one horizontal scanning period includes a horizontal back porch period (HBP) in which a pre-charge operation is performed, a horizontal display period in which a normal operation is performed, and a horizontal front porch period (HFP) in which a post-charge operation is performed.

In the horizontal back porch period, all of the first selection signal SEL1 to the fourth selection signal SEL4 supplied from the driving IC 210 to the liquid crystal panel 100 are turned on, and all of the four switching elements 11 included in each demultiplexer in the signal line driving circuit 9 are turned on. In such a horizontal back porch period, a constant pre-charge voltage is supplied from the driving IC 210 to the video signal terminal 12. As a result, the pre-charge voltage is supplied to all the signal lines 5, and the pre-charge voltage is written in all the pixels P coupled to one scanning line 6.

In the horizontal display period, the first selection signal SEL1 to the fourth selection signal SEL4 supplied from the driving IC 210 to the liquid crystal panel 100 are exclusively and sequentially turned on, so that the four switching elements 11 included in each demultiplexer 35 in the signal line driving circuit 9 are also exclusively and sequentially turned on. The video signal VID is distributed and input to the video signal terminal 12 in synchronization with an on-timing of each switching element 11, so that a desired video signal VID is supplied to each signal line 5. As a result, a voltage corresponding to the video signal VID is written to all the pixels P coupled to one scanning line 6, and a video corresponding to the video signal VID is displayed.

In the horizontal front porch period, all of the first selection signal SEL1 to the fourth selection signal SEL4 supplied from the driving IC 210 to the liquid crystal panel 100 are turned off, and all of the four switching elements 11 included in each demultiplexer 35 in the signal line driving circuit 9 are turned off. In such a horizontal front porch period, a constant voltage is supplied from the driving IC 210 to the video signal terminal 12.

In one horizontal scanning period as described above, the horizontal back porch period, in which the pre-charge operation is performed, is a period in which the load on the liquid crystal panel 100 is the largest relative to the driving IC 210. Therefore, the power supply noise generated in the horizontal back porch period, in which the pre-charge operation is performed, is the largest in one horizontal scanning period.

In one horizontal scanning period, the horizontal display period, in which the normal operation is performed, is a period in which the load on the liquid crystal panel 100 relative to the driving IC 210 is changed by the video signal VID. For example, when the video signal VID involving a large change in voltage value is supplied to the liquid crystal panel 100 as when a dot pattern is displayed on the liquid crystal panel 100, the load on the liquid crystal panel 100 is large relative to the driving IC 210. As described above, the magnitude of the power supply noise generated in the horizontal display period, in which the normal operation is performed, in one horizontal scanning period varies depending on the video signal VID.

In one horizontal scanning period, the horizontal front porch period, in which the post-charge operation is performed, is a period in which the load on the liquid crystal panel 100 relative to the driving IC 210 is the smallest. Therefore, the power supply noise generated in the horizontal front porch period, in which the post-charge operation is performed, is the smallest in one horizontal scanning period.

The second control circuit 64 controls the A/D converter 63 to make the forward voltage Vf of the diode 51 taken into the A/D converter 63 during the horizontal front porch period in one horizontal scanning period. Thus, the second control circuit 64 controls the A/D converter 63 to make the forward voltage Vf of the diode 51 taken into the A/D converter 63 in the flyback period included in the horizontal scanning period. Therefore, an impact of the power supply noise on the forward voltage Vf of the diode 51 taken into the A/D converter 63 can be suppressed as much as possible, whereby it is possible to further improve the temperature measurement accuracy of the liquid crystal panel 100.

When the post-charge operation is performed before and after the horizontal back porch period, in which the pre-charge operation is performed, the second control circuit 64 may control the A/D converter 63 to make the forward voltage Vf of the diode 51 taken into the A/D converter 63 during the period in which the post-charge operation is performed before and after the horizontal back porch period.

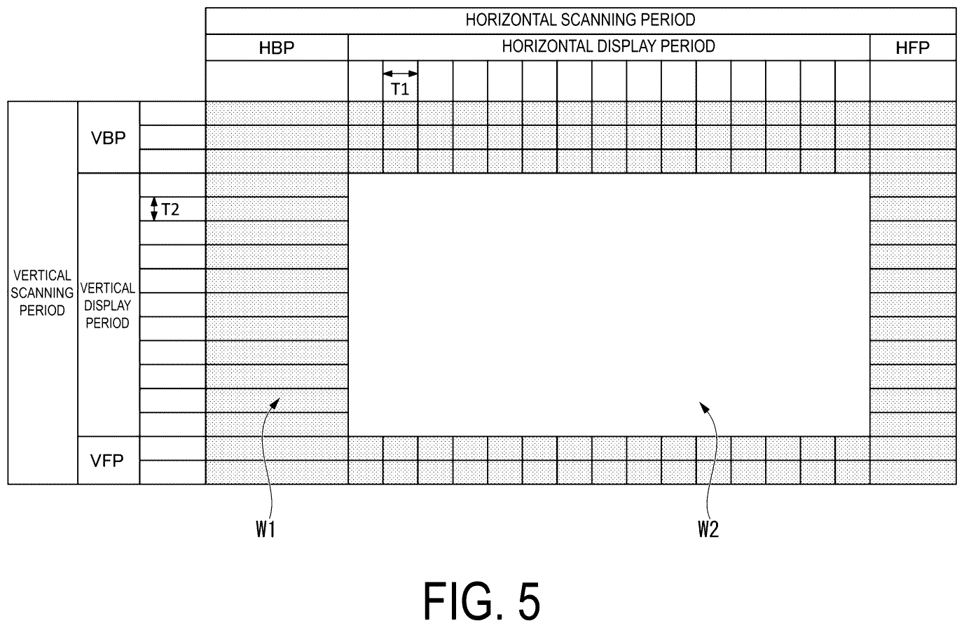

FIG. 5 is a diagram schematically illustrating the video signal VID in one frame period. As illustrated in FIG. 5, the video signal VID in one frame period has the flyback period not only in the horizontal scanning period but also in a vertical scanning period. The vertical scanning period includes a vertical back porch period (VBP) and a vertical front porch period (VFP) as flyback periods. Note that in FIG. 5, a region W1 illustrated with a hatched pattern is a region of a flyback period included in one frame period. A blank region W2 corresponds to an effective pixel area of the liquid crystal panel 100. Symbol T1 corresponds to one block of the demultiplexer, and symbol T2 corresponds to one line of the scanning line 6.

The second control circuit 64 controls the A/D converter 63 to make the forward voltage Vf of the diode 51 taken into the A/D converter 63 in the flyback period included in the vertical scanning period. Therefore, an impact of the power supply noise on the forward voltage Vf of the diode 51 taken into the A/D converter 63 can be further suppressed, whereby it is possible to further improve the temperature measurement accuracy of the liquid crystal panel 100. When the temperature of the liquid crystal panel 100 is measured in the flyback period included in the vertical scanning period as described above, it is desirable to measure the temperature of the liquid crystal panel 100 with the signal output from the driving IC 210 to the liquid crystal panel 100 stopped.

### Effects of First Embodiment

As described above, the display module 1000 according to the first embodiment includes the liquid crystal panel 100 that includes the diode 51 serving as the temperature detection element and is configured to display an image, the wiring board 200 that includes the driving IC 210 configured to drive the liquid crystal panel 100, and the circuit board 300 that includes the first control circuit 310 configured to control the driving IC 210 and is electrically coupled to the liquid crystal panel 100 via the wiring board 200. The driving IC 210 includes the measurement circuit 220 configured to measure the temperature of the liquid crystal panel 100 based on the forward voltage Vf of the diode 51 in the flyback period of the liquid crystal panel 100.

In the first embodiment as described above, the driving IC 210 disposed on the wiring board 200 that electrically couples the liquid crystal panel 100 to the circuit board 300 includes the measurement circuit 220. Therefore, the distance between the diode 51, which is the temperature detection element disposed on the liquid crystal panel 100, and the measurement circuit 220 is shorter than that with the known technique in which the measurement circuit 220 is disposed on the circuit board 300. Therefore, according to the first embodiment, the forward voltage Vf of the diode 51 taken into the measurement circuit 220 is less likely to be affected by disturbance noise than with the known technique, whereby it is possible to improve the temperature measurement accuracy of the liquid crystal panel 100.

In the first embodiment, the measurement circuit 220 measures the temperature of the liquid crystal panel 100 based on the forward voltage Vf of the diode 51 in the flyback period of the liquid crystal panel 100. Therefore, an impact of the power supply noise on the forward voltage Vf of the diode 51 taken into the measurement circuit 220 can be suppressed, whereby it is possible to further improve the temperature measurement accuracy of the liquid crystal panel 100.

In the display module 1000 according to the first embodiment, the flyback period of the liquid crystal panel 100 is a flyback period included in the horizontal scanning period.

In such a first embodiment, an impact of the power supply noise, generated in the horizontal scanning period, on the forward voltage Vf of the diode 51 taken into the measurement circuit 220 can be suppressed, whereby it is possible to further improve the temperature measurement accuracy of the liquid crystal panel 100.

In the display module 1000 according to the first embodiment, the flyback period of the liquid crystal panel 100 is a flyback period included in the vertical scanning period.

In such a first embodiment, an impact of the power supply noise, generated in the vertical scanning period, on the forward voltage Vf of the diode 51 taken into the measurement circuit 220 can be suppressed, whereby it is possible to further improve the temperature measurement accuracy of the liquid crystal panel 100.

In the display module 1000 according to the first embodiment, the measurement circuit 220 includes the constant current source 61 configured to supply the driving current Id to the diode 51, the A/D converter 63 configured to convert the forward voltage Vf of the diode 51 into a digital value, and the second control circuit 64 configured to control the A/D converter 63 to make the forward voltage Vf of the diode 51 taken into the A/D converter 63 in the flyback period of the liquid crystal panel 100.

In such a first embodiment, the distance between the diode 51, which is the temperature detection element disposed on the liquid crystal panel 100, and the A/D converter 63 included in the measurement circuit 220 is shorter than that with the known technique in which the measurement circuit 220 is disposed on the circuit board 300. Therefore, according to the first embodiment, the forward voltage Vf of the diode 51 taken into the A/D converter 63 is less likely to be affected by disturbance noise than with the known technique, whereby it is possible to improve the temperature measurement accuracy of the liquid crystal panel 100.

In the first embodiment, the second control circuit 64 controls the A/D converter 63 to make the forward voltage Vf of the diode 51 taken into the A/D converter 63 in the flyback period of the liquid crystal panel 100. Therefore, an impact of the power supply noise on the forward voltage Vf of the diode 51 taken into the A/D converter 63 can be suppressed, whereby it is possible to further improve the temperature measurement accuracy of the liquid crystal panel 100.

In the display module 1000 according to the first embodiment, the liquid crystal panel 100 includes the signal line driving circuit 9 including the plurality of demultiplexers 35.

The liquid crystal panel 100 operated by the signal line driving circuit 9 including the plurality of demultiplexers 35 generates relatively large power supply noise. Therefore, it is possible to more effectively suppress the impact of the power supply noise, by adopting the configuration in which the driving IC 210 disposed on the wiring board 200 includes the measurement circuit 220 and the measurement circuit 220 measures the temperature of the liquid crystal panel 100 based on the forward voltage Vf of the diode 51 in the flyback period of the liquid crystal panel 100.

In the display module 1000 according to the first embodiment, the temperature detection element is the diode 51.

In such a first embodiment, the temperature detection element can be formed in the liquid crystal panel 100 together with the pixel switching element and the like. Thus, it is not necessary to use a further temperature detection element such as a thermistor for detecting the temperature of the liquid crystal panel 100.

### 2. Second Embodiment of Display Module

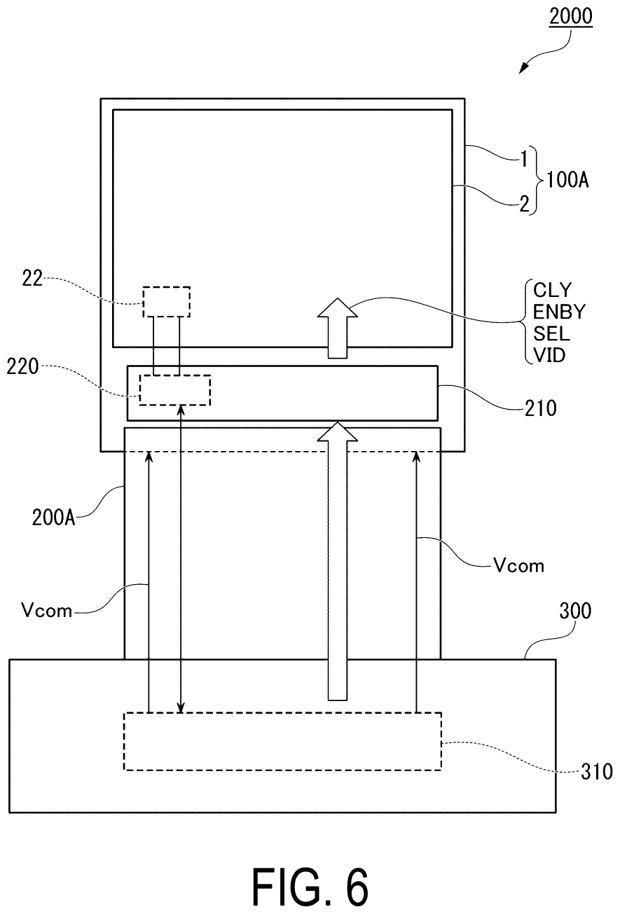

FIG. 6 is a diagram illustrating a schematic configuration of a display module 2000 according to a second embodiment. In the second embodiment exemplified below, the same reference numerals as those used in the first embodiment will be assigned to configurations common to the first embodiment, and detailed description thereof will be omitted as appropriate.

As illustrated in FIG. 6, the display module 2000 includes a liquid crystal panel 100A, a wiring board 200A, and the circuit board 300. The liquid crystal panel 100A according to the second embodiment is different from the liquid crystal panel 100 according to the first embodiment in that the driving IC 210 including the measurement circuit 220 is provided. For example, in the second embodiment, the driving IC 210 is disposed in a region below the counter substrate 2 in a surface region of the element substrate 1. In the liquid crystal panel 100A, the temperature detection circuit 22 is electrically coupled to the measurement circuit 220 included in the driving IC 210 disposed on the element substrate 1.

The liquid crystal panel 100A is electrically coupled to the circuit board 300 via the wiring board 200A. The wiring board 200A according to the second embodiment electrically couples the liquid crystal panel 100A to the circuit board 300, and does not include the driving IC 210.

As in the first embodiment, the clock signal CLY, the output control signal ENBY, the selection signal SEL, the video signal VID, and the like are supplied from the driving IC 210 to the liquid crystal panel 100A. The common potential Vcom is directly supplied from the first control circuit 310 of the circuit board 300 to the liquid crystal panel 100A. The first control circuit 310 controls the driving IC 210 so that various signals necessary for driving of the liquid crystal panel 100A are output from the driving IC 210 at the time of the normal driving of the liquid crystal panel 100A. The driving IC 210 outputs the clock signal CLY, the output control signal ENBY, the video signal VID, the selection signal SEL, and the like to the liquid crystal panel 100A under the control of the first control circuit 310.

In the second embodiment, the driving IC 210 disposed on the liquid crystal panel 100A includes the measurement circuit 220. Therefore, the distance between the diode 51, which is the temperature detection element disposed on the liquid crystal panel 100A, and the A/D converter 63 included in the measurement circuit 220 is shorter than that with the first embodiment in which the driving IC 210 is disposed on the wiring board 200. Therefore, according to the second embodiment, the forward voltage Vf of the diode 51 taken into the A/D converter 63 is less likely to be affected by disturbance noise than in the first embodiment, whereby it is possible to further improve the temperature measurement accuracy of the liquid crystal panel 100A.

Also in the second embodiment, the second control circuit 64 included in the measurement circuit 220 controls the A/D converter 63 to make the forward voltage Vf of the diode 51 taken into the A/D converter 63 in the flyback period of the liquid crystal panel 100A. Thus, as in the first embodiment, an impact of the power supply noise on the forward voltage Vf of the diode 51 taken into the A/D converter 63 can be suppressed as much as possible, whereby it is possible to further improve the temperature measurement accuracy of the liquid crystal panel 100A.

### Effects of Second Embodiment

As described above, the display module 2000 according to the second embodiment includes the liquid crystal panel 100A that includes the diode 51 serving as the temperature detection element and is configured to display an image, the wiring board 200A, and the circuit board 300 that is electrically coupled to the liquid crystal panel 100A via the wiring board 200A. The liquid crystal panel 100A includes the driving IC 210 that drives the liquid crystal panel 100A. The circuit board 300 includes the first control circuit 310 that controls the driving IC 210. The driving IC 210 includes the measurement circuit 220 configured to measure the temperature of the liquid crystal panel 100A based on the forward voltage Vf of the diode 51 in the flyback period of the liquid crystal panel 100A.

In the second embodiment as described above, the driving IC 210 disposed on the liquid crystal panel 100A includes the measurement circuit 220. Therefore, the distance between the diode 51, which is the temperature detection element disposed on the liquid crystal panel 100A, and the measurement circuit 220 is shorter than that with the first embodiment in which the driving IC 210 is disposed on the wiring board 200. Therefore, according to the second embodiment, the forward voltage Vf of the diode 51 taken into the measurement circuit 220 is less likely to be affected by disturbance noise than in the first embodiment, whereby it is possible to further improve the temperature measurement accuracy of the liquid crystal panel 100A.

Also in the second embodiment, the measurement circuit 220 measures the temperature of the liquid crystal panel 100A based on the forward voltage Vf of the diode 51 in the flyback period of the liquid crystal panel 100A as in the first embodiment. Therefore, an impact of the power supply noise on the forward voltage Vf of the diode 51 taken into the measurement circuit 220 can be suppressed, whereby it is possible to further improve the temperature measurement accuracy of the liquid crystal panel 100A.

### 3. Overview of Electronic Device

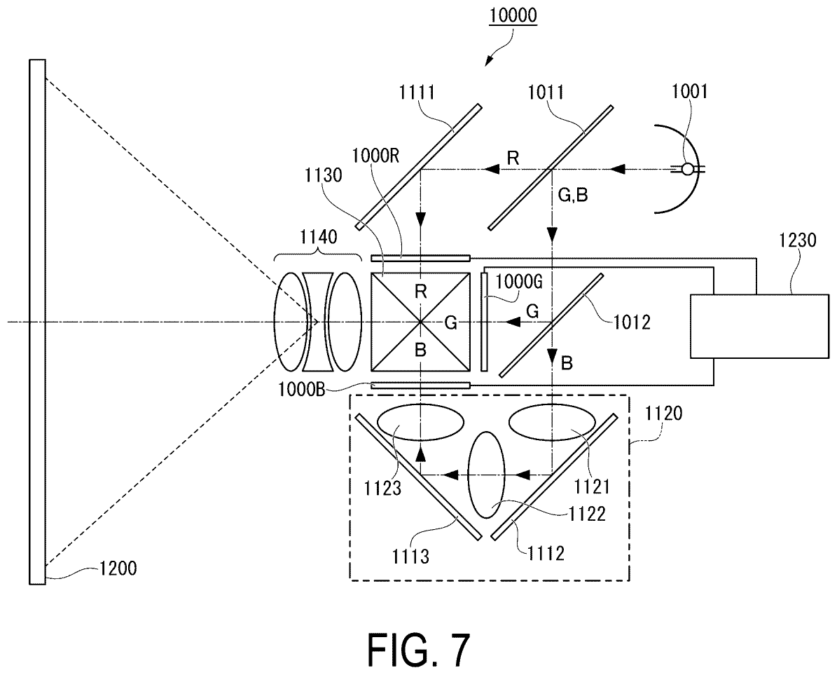

FIG. 7 is a schematic configuration diagram illustrating a configuration of a projector that is an electronic device. A projector 10000 will be described below as an example of an electronic device including the display module 1000 according to the first embodiment.

The projector 10000 is a three-panel type projector and includes a lamp unit 1001 serving as a light source, dichroic mirrors 1011 and 1012 serving as color separation optical systems, a display module 1000B corresponding to blue light B, a display module 1000G corresponding to green light G, a display module 1000R corresponding to red light R, three reflection mirrors 1111, 1112, and 1113, three relay lenses 1121, 1122, and 1123, a dichroic prism 1130 serving as a color synthesis optical system, and a projection lens 1140 serving as a projection optical system. A video is projected onto a screen 1200 by the projection optical system. Further, the relay lenses 1121, 1122, and 1123 and the reflection mirrors 1112 and 1113 form a relay lens system 1120.

In addition, the projector 10000 includes a circuit board 1230 electrically coupled to the display modules 1000B, 1000G, and 1000R. The circuit board 1230 is obtained by combining the circuit boards 300 of the display modules 1000B, 1000G, and 1000R into one substrate.

Although the embodiments of the present disclosure have been described above, the technical scope of the present disclosure is not limited to the above embodiments, and various changes can be made without departing from the gist of the present disclosure.

For example, in the above-described embodiments, the liquid crystal panels 100 and 100A are described as examples of the electro-optical device, but the electro-optical device of the present disclosure is not limited to the liquid crystal panels, and may be another electro-optical device such as an organic light emitting diode (OLED) panel. In the present embodiment, the projector 10000 is described as an example of an electronic device, but the electronic device including the display module of the present disclosure is not limited thereto. For example, the display module of the present disclosure may be applied to an electronic device such as a 3D printer that cures a resin liquid using light emitted from a liquid crystal panel, a head-up display (HUD), a head mounted display (HMD), a personal computer, a digital camera, or a liquid crystal television.

### Overview of Present Disclosure

An overview of the present disclosure is provided below as the appendices.

### APPENDIX 1

A display module including an electro-optical device that includes a temperature detection element and is configured to display an image, a wiring board that includes a driving circuit configured to drive the electro-optical device, and a circuit board that includes a first control circuit configured to control the driving circuit and is electrically coupled to the electro-optical device via the wiring board, wherein the driving circuit includes a measurement circuit configured to measure a temperature of the electro-optical device based on an output signal from the temperature detection element in a flyback period of the electro-optical device.

In the display module according to Appendix 1, the driving circuit disposed on the wiring board that electrically couples the electro-optical device to the circuit board includes the measurement circuit. Therefore, the distance between the temperature detection element disposed in the electro-optical device and the measurement circuit is shorter than that with the known technique in which the measurement circuit is disposed on the circuit board. Therefore, with the display module according to Appendix 1, since the output signal from the temperature detection element taken into the measurement circuit is less likely to be affected by disturbance noise than with the known technique, it is possible to improve the temperature measurement accuracy of the electro-optical device.

The measurement circuit measures the temperature of the electro-optical device based on the output signal of the temperature detection signal in the flyback period of the electro-optical device. Accordingly, the impact of the power supply noise on the output signal of the temperature detection element taken into the measurement circuit can be suppressed, and thus it is possible to further improve the temperature measurement accuracy of the electro-optical device.

### APPENDIX 2

A display module including an electro-optical device that includes a temperature detection element and is configured to display an image, a wiring board, and a circuit board that is electrically coupled to the electro-optical device via the wiring board, wherein the electro-optical device includes a driving circuit configured to drive the electro-optical device, the circuit board includes a first control circuit configured to control the driving circuit, and the driving circuit includes a measurement circuit configured to measure a temperature of the electro-optical device based on an output signal from the temperature detection element in a flyback period of the electro-optical device.

In the display module according to Appendix 2, the driving circuit disposed in the electro-optical device includes the measurement circuit. Therefore, the distance between the temperature detection element disposed in the electro-optical device and the measurement circuit is shorter than that with the display module according to Appendix 1, in which the driving circuit is disposed on the wiring board. Therefore, with the display module according to Appendix 2, since the output signal from the temperature detection element taken into the measurement circuit is less likely to be affected by disturbance noise than with the display module according to Appendix 1, it is possible to further improve the temperature measurement accuracy of the electro-optical device.

Also in the display module according to Appendix 2, the measurement circuit measures the temperature of the electro-optical device based on the output signal from the temperature detection element in the flyback period of the electro-optical device, as in the display module according to Appendix 1. Accordingly, the impact of the power supply noise on the output signal from the temperature detection element taken into the measurement circuit can be suppressed, and thus it is possible to further improve the temperature measurement accuracy of the electro-optical device.

### APPENDIX 3

The display module according to Appendix 1 or 2, wherein the flyback period is included in a horizontal scanning period.

With the display module according to Appendix 3, the impact of the power supply noise generated in the horizontal scanning period on the output signal from the temperature detection element taken into the measurement circuit can be suppressed, and thus it is possible to further improve the temperature measurement accuracy of the electro-optical device.

### APPENDIX 4

The display module according to any one of Appendix 1 to Appendix 3, wherein the flyback period is included in a vertical scanning period.

With the display module according to Appendix 4, the impact of the power supply noise generated in the vertical scanning period on the output signal from the temperature detection element taken into the measurement circuit can be suppressed, and thus it is possible to further improve the temperature measurement accuracy of the electro-optical device.

### APPENDIX 5

The display module according to any one of Appendix 1 to Appendix 4, wherein the measurement circuit includes a constant current source configured to supply a current to the temperature detection element, an A/D converter configured to convert an output signal from the temperature detection element into a digital value, and a second control circuit configured to control the A/D converter to make the output signal from the temperature detection element taken into the A/D converter in the flyback period.

In the display module according to Appendix 5, the distance between the temperature detection element disposed in the electro-optical device and the A/D converter included in the measurement circuit is shorter than that with the known technique in which the measurement circuit is disposed on the circuit board. Therefore, since the output signal from the temperature detection element taken into the A/D converter is less likely to be affected by disturbance noise than with the known technique, it is possible to improve the temperature measurement accuracy of the electro-optical device.

The second control circuit controls the A/D converter to make the output signal from the temperature detection element taken into the A/D converter in the flyback period of the electro-optical device. Accordingly, the impact of the power supply noise on the output signal from the temperature detection element taken into the A/D converter can be suppressed, and thus it is possible to further improve the temperature measurement accuracy of the electro-optical device.

### APPENDIX 6

The display module according to any one of Appendix 1 to Appendix 5, wherein the electro-optical device includes a signal line driving circuit including a plurality of demultiplexers.

The electro-optical device operated by the signal line driving circuit including the plurality of demultiplexers generates relatively large power supply noise. Thus, by employing the configuration of the display module according to Appendix 1 or 2, the impact of power supply noise can be suppressed more effectively.

### APPENDIX 7

The display module according to any one of Appendix 1 to Appendix 6, wherein the temperature detection element is a diode.

With the display module according to Appendix 7, the temperature detection element can be formed in the electro-optical device together with a pixel switching element and the like. Thus, it is not necessary to use a further temperature detection element such as a thermistor for detecting the temperature of the electro-optical device.

### APPENDIX 8

An electronic device including the display module according to any one of Appendix 1 to Appendix 7.

According to Appendix 8, it is possible to provide an electronic device including a display module with improved temperature measurement accuracy of the electro-optical device.

What is claimed is:

1. A display module comprising:
an electro-optical device that includes a temperature detection element and is configured to display an image;
a wiring board that includes a driving circuit configured to drive the electro-optical device; and
a circuit board that includes a first control circuit configured to control the driving circuit and is electrically coupled to the electro-optical device via the wiring board, wherein
the driving circuit includes a measurement circuit configured to measure a temperature of the electro-optical device based on an output signal from the temperature detection element in a flyback period of the electro-optical device.

2. A display module comprising:
an electro-optical device that includes a temperature detection element and is configured to display an image;
a wiring board; and
a circuit board that is electrically coupled to the electro-optical device via the wiring board, wherein
the electro-optical device includes a driving circuit configured to drive the electro-optical device,
the circuit board includes a first control circuit configured to control the driving circuit, and
the driving circuit includes a measurement circuit configured to measure a temperature of the electro-optical device based on an output signal from the temperature detection element in a flyback period of the electro-optical device.

3. The display module according to claim 1, wherein the flyback period is included in a horizontal scanning period.

4. The display module according to claim 1, wherein the flyback period is included in a vertical scanning period.

5. The display module according to claim 1, wherein
the measurement circuit includes:
a constant current source configured to supply a current to the temperature detection element;
an A/D converter configured to convert an output signal from the temperature detection element into a digital value; and
a second control circuit configured to control the A/D converter to make the output signal from the temperature detection element taken into the A/D converter in the flyback period.

6. The display module according to claim 1, wherein the electro-optical device includes a signal line driving circuit including a plurality of demultiplexers.

7. The display module according to claim 1, wherein the temperature detection element is a diode.

8. An electronic device comprising the display module according to claim 1.
